(19) United States
(12) Patent Application Publication
(10) Pub. No.: US 2026/0371178 A1
(43) Pub. Date: Nov. 19, 2026

(54) METHOD FOR MOBILE INTEGRATED ACCESS AND BACKHAUL

(71) Applicant: ZTE CORPORATION, Shenzhen, Guangdong (CN)

(72) Inventors: Wanfu XU, Shenzhen (CN); Lin CHEN, Shenzhen (CN); Ying HUANG, Shenzhen (CN); Tao QI, Shenzhen (CN)

(21) Appl. No.: 19/148,033

(22) PCT Filed: Feb. 16, 2023
(86) PCT No.: PCT/CN2023/076552

§ 371 Date: Jul. 15, 2025

(51) Int. Cl. H04W 36/00; H04W 36/08; H04W 36/30

(52) U.S. Cl. CPC H04W 36/0058; H04W 36/08; H04W 36/30

(57) ABSTRACT

A wireless communication method for use in a wireless terminal is disclosed. The method comprises receiving, from a wireless network node, at least one configuration parameter for an on-board type terminal, identifying as the on-board type terminal, and performing an operation by using the at least one configuration parameter for the on-board type terminal.

This document is directed generally to wireless communications, and in particular to 5G communications.

Demand for improved 5G cellular coverage and connectivity continues to increase, which may be challenging in many outdoor and mobility scenarios. In some outdoor environments, the availability of vehicles equipped with mobile base station relays, either following a certain known/predictable itinerary (e.g., buses, trams, etc.), or situated in convenient locations (e.g., outside stadiums, hot-spot areas, or emergency sites), could provide very opportunistic boost to cellular coverage and capacity when/where needed. Those relays, using 5G wireless backhaul toward the macro network, could indeed offer better 5G coverage and connectivity to neighboring UEs (user equipments). Vehicle relays are obviously very suitable also for improving the connectivity for users or devices inside the vehicle itself, in different environments, e.g., for passengers in buses, car/taxi, or trains, ad-hoc/professional personnel or equipment. Yet other target scenarios are where vehicle relays can be used for reaching the users or devices that would otherwise have no or very poor macro coverage, e.g., in case of first responders dislocated in indoor buildings/areas, using 5G relays placed on their nearby/outside vehicles to get required 5G coverage and connectivity.

The technical benefits of using vehicle relays include, among others, the ability of the BS relay to get better macro coverage than a nearby UE, e.g., exploiting better RF/antenna and power capabilities. Besides the value for network operators and end users, worthy incentives could be found for other parties as well, e.g., for vehicles manufacturers, vehicle/fleet owners or providers, to install and operate relays in their vehicles.

This document relates to methods, systems, and devices for cell selection/reselection for a mobile network node, and in particular to methods, systems, and devices for cell selection/reselection for onboard UE communicates with a mobile network node.

The present disclosure relates to a wireless communication method for use in a wireless terminal. The method comprises:

receiving, from a wireless network node, at least one configuration parameter for an on-board type terminal,

identifying as the on-board type terminal, and

performing an operation by using the at least one configuration parameter for the on-board type terminal.

Various embodiments may preferably implement the following features:

Preferably, the at least one configuration parameter comprises at least one cell reselection parameter for the on-board type terminal.

Preferably, performing the operation by using the at least one configuration parameter for the on-board type terminal comprises: performing a cell reselection process by using the at least one cell reselection parameter.

Preferably, the at least one configuration parameter comprises a hysteresis value and/or an offset value for the cell reselection.

Preferably, performing the cell reselection process by using the at least one cell reselection parameter comprises:

determining a serving cell quality metric and/or at least one neighbor cell quality metric by using the at least one cell reselection parameter, and

performing the cell reselection process based on the serving cell quality metric and/or the at least one neighbor cell quality metric.

Preferably, the at least one configuration parameter comprises a low mobility relaxed measurement threshold and/or an edging cell relaxed measurement.

Preferably, performing the operation by using the at least one configuration parameter for the on-board type terminal comprises: determining whether to perform a relaxed measurement based on the low mobility relaxed measurement threshold and/or the edging cell relaxed measurement threshold.

Preferably, identifying as the on-board terminal comprises: identifying as the on-board terminal if determining that a cell to which the wireless terminal accesses is a mobile Integrated Access and Backhaul node.

Preferably, identifying as the on-board terminal comprises: identifying as the on-board terminal if determining that a relative moving speed between the cell and the wireless terminal is smaller than a threshold.

Preferably, identifying as the on-board terminal comprises: identifying as the on-board terminal if determining that a closed access group (CAG) identifier of the cell is in an allowed closed access group list, wherein the wireless terminal supports CAG functionality.

Preferably, identifying as the on-board terminal comprises: identifying as the on-board terminal if determining that at least one tracking area broadcasted by a cell on which the wireless terminal camps is not in a list of Forbidden Tracking Areas for Roaming, wherein the cell is provided by the mobile Integrated Access and Backhaul node.

The present disclosure relates to a wireless communication method for use in a wireless network node. The method comprises:

transmitting, to a wireless terminal, at least one configuration parameter for an on-board type terminal.

Various embodiments may preferably implement the following features:

Preferably, the at least one configuration parameter comprises at least one cell reselection parameter for the on-board type terminal.

Preferably, the at least one cell reselection parameter is used for a cell reselection process.

Preferably, the at least one configuration parameter comprises a hysteresis value and/or an offset value for the cell reselection.

Preferably, the at least one configuration parameter comprises a low mobility relaxed measurement threshold and/or an edging cell relaxed measurement.

Preferably, the serving cell quality metric and/or the at least one neighbor cell quality metric is used for determining whether a relaxed measurement is performed by the wireless terminal The present disclosure relates to a wireless communication method for use in a first wireless network node. The method comprises:

receiving, from a second wireless network node, location information of a wireless terminal, and

transmitting, to an access and mobility management function, the location information Various embodiments may preferably implement the following features:

Preferably, the wireless communication method further comprises: transmitting, to the second wireless network node, a request for the location information of the wireless terminal.

Preferably, the first wireless network node and the second wireless network node are integrated access and backhaul donors of the wireless terminal.

Preferably, the first wireless network node is an F1-terminating integrated access and backhaul donor of the wireless terminal and the second wireless network node is a non-F1-terminating integrated access and backhaul donor of the wireless terminal.

The present disclosure relates to a wireless communication method for use in a second wireless network node. The method comprises: transmitting, to a first wireless network node, location information of a wireless terminal.

Various embodiments may preferably implement the following features:

Preferably, the wireless communication method further comprises: receiving, from the first wireless network node, a request for the location information of the wireless terminal.

Preferably, the first wireless network node and the second wireless network node are integrated access and backhaul donors of the wireless terminal.

Preferably, the first wireless network node is an F1-terminating integrated access and backhaul donor of the wireless terminal and the second wireless network node is a non-F1-terminating integrated access and backhaul donor of the wireless terminal.

The present disclosure relates to a wireless communication method for use in a third wireless network node. The method comprises:

receiving, from a fourth wireless network node, tracking area code (TAC) related information associated with a mobile network node, and

performing an operation for the mobile network node based on the TAC related information.

Various embodiments may preferably implement the following features:

Preferably, the transport migration procedure transfers a distributed unit of the mobile network node to a F1-terminating IAB-donor from (a path) via a source parent node to (another path) via a target parent node.

Preferably, performing the operation for the mobile network node based on the TAC information comprises:

determining a TAC based on the TAC related information, and

transmitted, to the mobile network node, the determined TAC.

Preferably, the determined TAC is not in a supported tracking area list.

Preferably, the wireless communication method further comprises: transmitting, to an access and mobility management function, the supported tracking area list which is updated to include the determined TAC.

Preferably, the wireless communication method further comprises: triggering a full migration for a mobile termination of the mobile network node and the distributed unit of the mobile network node.

Preferably, triggering a migration for the distributed unit of the mobile network node.

Preferably, the determined TAC is transmitted to the mobile network node in an F1 signaling in a transport migration procedure.

Preferably, the third wireless network node is an F1-terminating integrated access and backhaul donor associated with the mobile network node, the fourth wireless network node is a non-F1-terminating integrated access and backhaul donor associated with the mobile network node, and the mobile network node is an integrated access and backhaul node.

Preferably, a mobile termination of the mobile network node is transferred from a source donor to a target donor, wherein the fourth wireless network node is the source donor or the target donor.

The present disclosure relates to a wireless communication method for use in a fourth wireless network node. The method comprises:

transmitting, to a third wireless network node, tracking area code (TAC) related information associated with a mobile network node.

Various embodiments may preferably implement the following features:

Preferably, the third wireless network node is an F1-terminating integrated access and backhaul donor associated with the mobile network node, the fourth wireless network node is a non-F1-terminating integrated access and backhaul donor associated with the mobile network node, and the mobile network node is an integrated access and backhaul node.

Preferably, a mobile termination of the mobile network node is transferred from a source donor to a target donor, wherein the fourth wireless network node is the source donor or the target donor.

The present disclosure relates to a wireless communication method of a mobile network node. The method comprises:

migrating a mobile termination of the mobile network node to a fifth wireless network node,

receiving, from the fifth wireless network node, tracking area code (TAC) allocated for the mobile network node, and

transmitting, to a sixth wireless network node, the TAC.

Various embodiments may preferably implement the following features:

Preferably, the TAC is received in a system information block or a radio resource control signaling from the fifth wireless network node.

Preferably, the wireless communication method further comprises:

receiving, from the sixth wireless network node, an acknowledge message, and

broadcasting the TAC information in a system information block.

Preferably, the sixth wireless network node is an F1-terminating integrated access and backhaul donor associated with the mobile network node, the fifth wireless network node is a non-F1-terminating integrated access and backhaul donor associated with the mobile network node, and the mobile network node is an integrated access and backhaul node.

The present disclosure relates to a wireless communication method for use in a fifth wireless network node. The method comprises:

transmitting, to a mobile network node, tracking area code (TAC) allocated for the mobile network node, wherein a mobile termination of the mobile network node is migrated to the fifth wireless network node.

Various embodiments may preferably implement the following features:

Preferably, the TAC is transmitted in a system information block or a radio resource control to the mobile network node.

Preferably, the sixth wireless network node is an F1-terminating integrated access and backhaul donor associated with the mobile network node, the fifth wireless network node is a non-F1-terminating integrated access and backhaul donor associated with the mobile network node, and the mobile network node is an integrated access and backhaul node.

The present disclosure relates to a wireless communication method for use in a mobile network node, the method comprising:

migrating a distributed unit of the mobile network node from a seventh wireless network node to an eighth wireless network node,

receiving, from the seventh wireless network node or the eighth wireless network node, a new radio cell global identity, and

replacing an old radio cell global identity with the new radio cell global identity.

Various embodiments may preferably implement the following feature:

Preferably, the mobile network node is an integrated access and backhaul node and the seventh wireless network node and the eighth wireless network node are F1-terminating integrated access and backhaul donors for the mobile network node.

The present disclosure relates to a wireless communication method for use in a seventh wireless network node. The method comprises:

receiving, from an eighth wireless network node, a new radio cell global identity for a mobile network node, wherein a distributed unit of the mobile network node is migrated to from the seventh wireless network node to the eighth wireless network node, and

transmitting, to the mobile network node, the new radio cell global identity.

Various embodiments may preferably implement the following feature:

Preferably, the mobile network node is an integrated access and backhaul node and the seventh wireless network node and the eighth wireless network node are F1-terminating integrated access and backhaul donors for the mobile network node.

The present disclosure relates to wireless communication method for use in an eighth wireless network node. The method comprises:

transmitting, to a mobile network node or a seventh wireless network node, a new radio cell global identity, wherein a distributed unit of the mobile network node is migrated to from the seventh wireless network node to the eighth wireless network node.

The present disclosure relates to a wireless terminal. The wireless terminal comprises:

a communication unit, configured to receive, from a wireless network node, at least one configuration parameter for an on-board type terminal, and

a processor, configured to:

identify as the on-board type terminal, and

perform an operation by using the at least one configuration parameter for the on-board type terminal.

Various embodiments may preferably implement the following feature:

Preferably, the processor is further configured to perform any of the aforementioned wireless communication methods.

The present disclosure relates to a wireless network node. The wireless network node comprises:

a communication unit, configured to transmit, to a wireless terminal, at least one configuration parameter for an on-board type terminal.

Various embodiments may preferably implement the following feature:

Preferably, the wireless network node further comprises a processor configured to perform any of the aforementioned wireless communication methods.

The present disclosure relates to a first wireless network node. The first wireless network node comprises:

a communication unit, configured to:

receive, from a second wireless network node, location information of a wireless terminal, and

transmit, to an access and mobility management function, the location information.

Various embodiments may preferably implement the following feature:

Preferably, the first wireless network node further comprises a processor configured to perform any of the aforementioned wireless communication methods.

The present disclosure relates to a second wireless network node. The second wireless network node comprises:

a communication unit, configured to transmit, to a first wireless network node, location information of a wireless terminal.

Various embodiments may preferably implement the following feature:

Preferably, the second wireless network node further comprises a processor configured to perform any of the aforementioned wireless communication methods.

The present disclosure relates to a third wireless network node. The third wireless network node comprises:

a communication unit, configured to receive, from a fourth wireless network node, tracking area code (TAC) related information associated with a mobile network node, and

a processor, configured to perform an operation for the mobile network node based on the TAC related information.

Various embodiments may preferably implement the following feature:

Preferably, the processor is further configured to perform any of the aforementioned wireless communication methods.

The present disclosure relates to a fourth wireless network node. The fourth wireless network node comprises:

a communication unit, configured to transmit, to a third wireless network node, tracking area code (TAC) related information associated with a mobile network node.

Various embodiments may preferably implement the following feature:

Preferably, the fourth wireless network node further comprises a processor configured to perform any of the aforementioned wireless communication methods.

The present disclosure relates to a mobile network node. The mobile network node comprises:

a processor, configured to migrate a mobile termination of the mobile network node to a fifth wireless network node, and

a communication unit, configured to:

receive, from the fifth wireless network node, tracking area code (TAC) allocated for the mobile network node,

transmit, to a sixth wireless network node, the TAC.

Various embodiments may preferably implement the following feature:

Preferably, the processor is further configured to perform any of the aforementioned wireless communication methods.

The present disclosure relates to a fifth wireless network node. The fifth wireless network node comprises:

a communication unit, configured to transmit, to a mobile network node, tracking area code (TAC) allocated for the mobile network node, wherein a mobile termination of the mobile network node is migrated to the fifth wireless network node.

Various embodiments may preferably implement the following feature:

Preferably, the fifth wireless network node further comprises a processor configured to perform any of the aforementioned wireless communication methods.

The present disclosure relates to a mobile network node. The mobile network node comprises:

a processor, configured to migrate a distributed unit of the mobile network node from a seventh wireless network node to an eighth wireless network node, and

a communication unit, configured to receive from the seventh wireless network node or the eighth wireless network node, a new radio cell global identity,

wherein the processor is further configured to replace an old radio cell global identity with the new radio cell global identity.

Various embodiments may preferably implement the following feature:

Preferably, the processor is further configured to perform any of the aforementioned wireless communication methods.

The present disclosure relates to a seventh wireless network node, comprising:

a communication unit, configured to:

receive, from an eighth wireless network node, a new radio cell global identity for a mobile network node, wherein a distributed unit of the mobile network node is migrated to from the seventh wireless network node to the eighth wireless network node, and

transmit, to the mobile network node, the new radio cell global identity.

Various embodiments may preferably implement the following feature:

Preferably, the seventh wireless network node further comprises a processor configured to perform any of the aforementioned wireless communication methods.

The present disclosure relates to an eighth wireless network node. The eighth wireless network node comprises:

a communication node, configured to transmit, to a mobile network node or a seventh wireless network node, a new radio cell global identity, wherein a distributed unit mobile termination of the mobile network node is migrated to from the seventh wireless network node to the eighth wireless network node.

The present disclosure relates to a computer program product comprising a computer-readable program medium code stored thereupon, the code, when executed by a processor, causing the processor to implement a wireless communication method recited in any one of foregoing methods.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The invention is specified by the independent claims. Preferred embodiments are defined in the dependent claims. In the following description, although numerous features may be designated as optional, it is nevertheless acknowledged that all features comprised in the independent claims are not to be read as optional.

The above and other aspects and their implementations are described in greater detail in the drawings, the descriptions, and the claims.

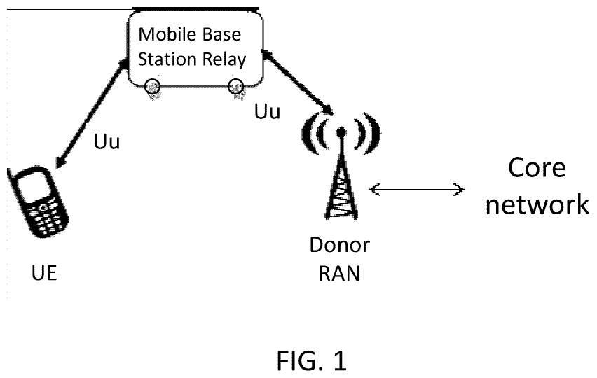

FIG. 1 shows a schematic diagram of a network according to an embodiment of the present disclosure.

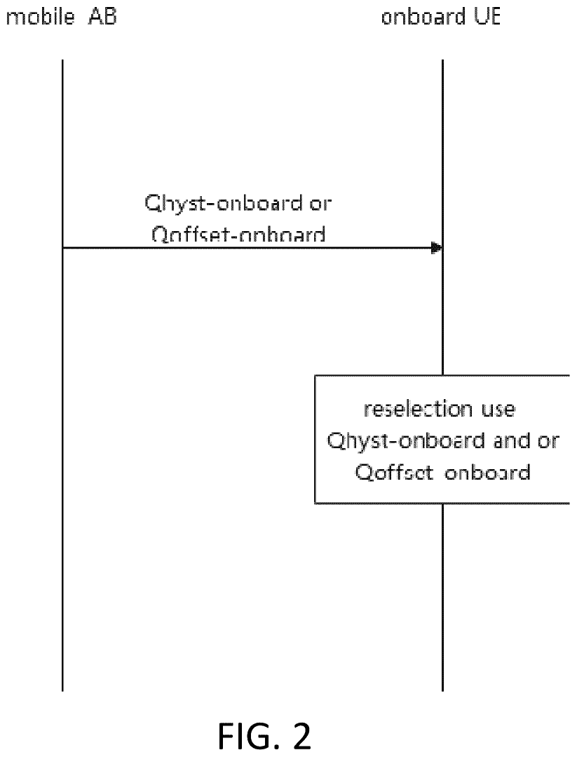

FIG. 2 shows a schematic diagram of a process according to an embodiment of the present disclosure.

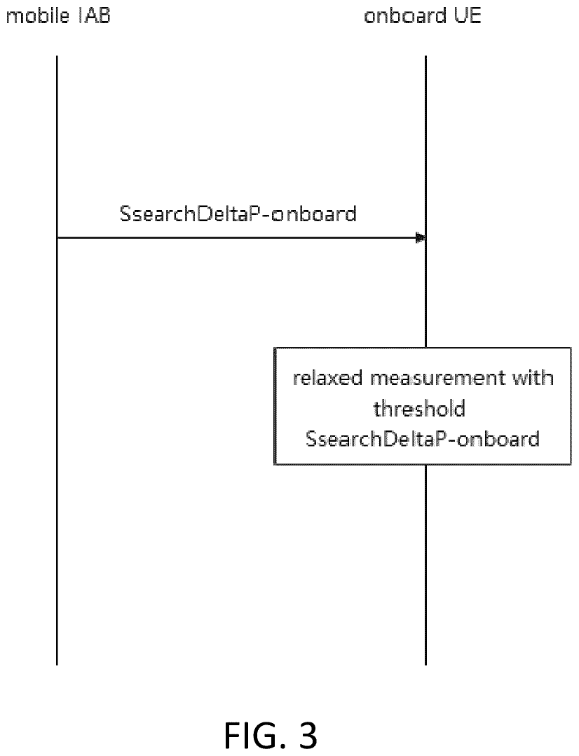

FIG. 3 shows a schematic diagram of a process according to an embodiment of the present disclosure.

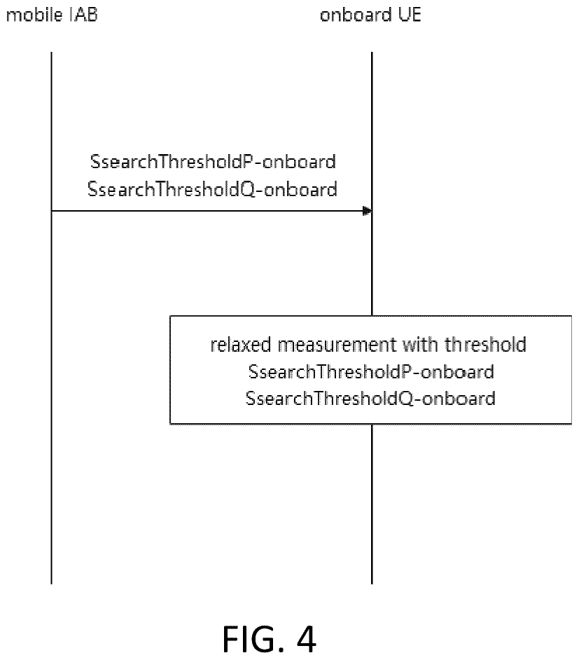

FIG. 4 shows a schematic diagram of a process according to an embodiment of the present disclosure.

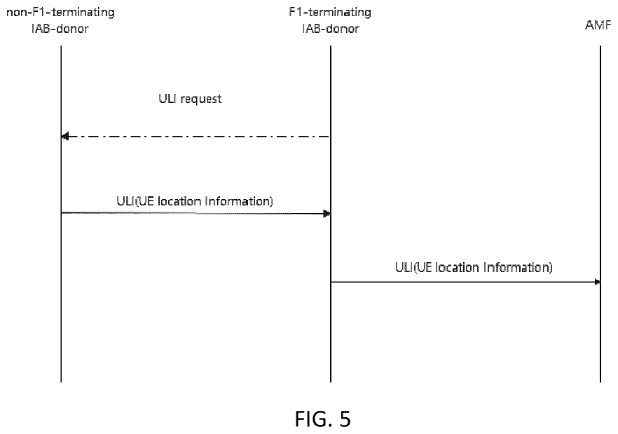

FIG. 5 shows a schematic diagram of a process according to an embodiment of the present disclosure.

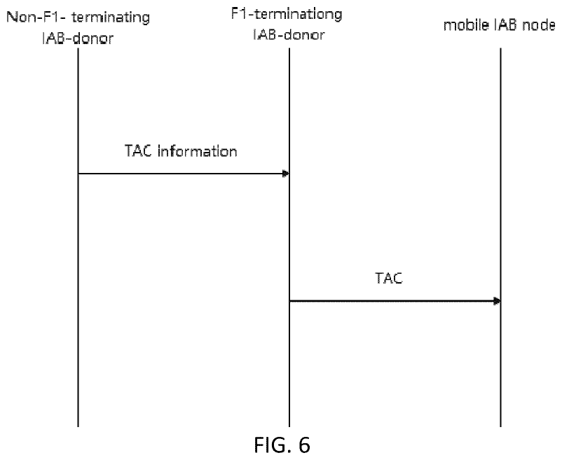

FIG. 6 shows a schematic diagram of a process according to an embodiment of the present disclosure.

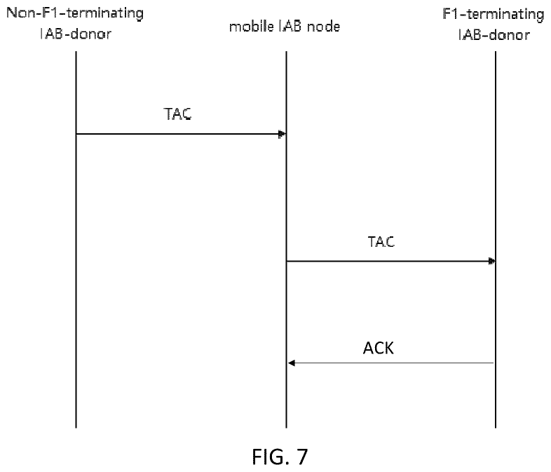

FIG. 7 shows a schematic diagram of a process according to an embodiment of the present disclosure.

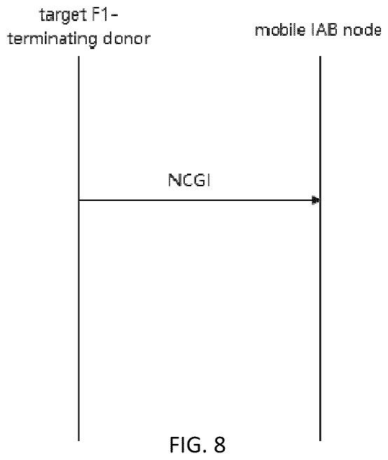

FIG. 8 shows a schematic diagram of a process according to an embodiment of the present disclosure.

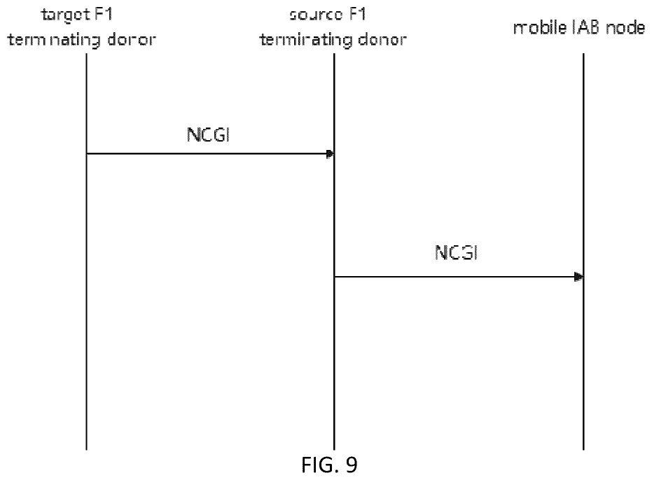

FIG. 9 shows a schematic diagram of a process according to an embodiment of the present disclosure.

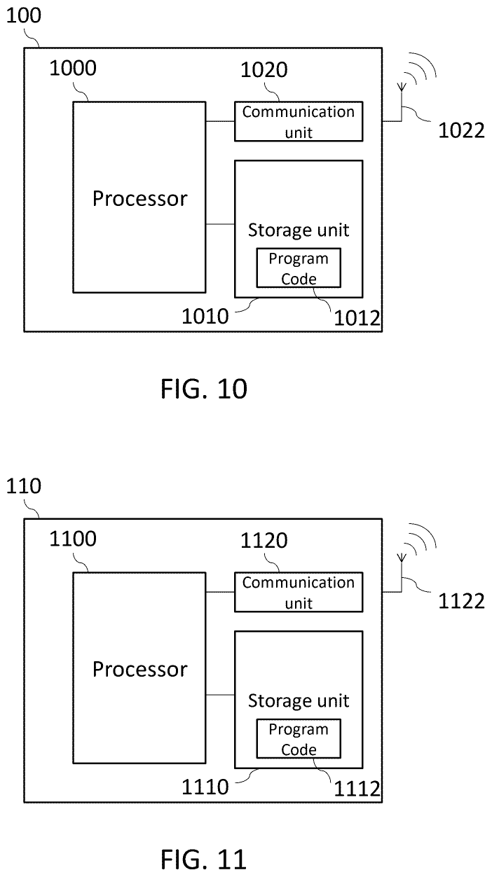

FIG. 10 shows an example of a schematic diagram of a wireless terminal according to an embodiment of the present disclosure.

FIG. 11 shows an example of a schematic diagram of a wireless network node according to an embodiment of the present disclosure.

In the present disclosure, from a high-level 5G system point of view, the target scenarios include moving vehicles equipped with small on board base station (BS) relays providing 5G coverage and communication to UEs (inside the vehicle and/or in its vicinity), and connected wirelessly to the 5G network via RAN (donor) nodes.

FIG. 1 shows a schematic diagram of a network (architecture) according to an embodiment of the present disclosure. In FIG. 1, the network comprises a UE, a mobile base station relay and a donor RAN (radio access network (node)). In an embodiment, the mobile base station relay is mounted on vehicles.

In an embodiment, the UE communicates with the donor RAN and/or a core network (e.g., 5GC (5 G core network)) via the mobile base station relay.

In an embodiment, the mobile base station relay is called IAB (Integrated Access and Backhaul) node.

In an embodiment, the donor RAN is called IAB-donor.

FIG. 2 shows a schematic diagram of a process according to an embodiment of the present disclosure. In FIG. 2, the mobile IAB node broadcasts cell reselection parameter Qhyst-onboard and/or Qoffset-onboard in the system information. The UE identifies itself as an onboard UE by implementation. The onboard UE performs a cell reselection based on the cell reselection parameter Qhyst-onboard and/or Qoffset-onboard. For example, the UE may determine Rs and/or Rn for a cell reselection process based on the Qhyst-onboard and or Qoffset-onboard, e.g.:

Rs=Qmeas,s+Qhyst-onboard−Qoffsettemp

Rn=Qmeas,n−Qoffset-onboard−Qoffsettemp

Or

Rs=Qmeas,s+Qhyst+Qhyst-onboard−Qoffsettemp

Rn=Qmeas,n−Qoffset−Qoffset-onboard−Qoffsettemp

In an embodiment, Rs refers to a signal quality metric (e.g., RSRP (reference signal received power) or RSRQ (reference signal received quality)) of a serving cell of the UE.

In an embodiment, Rn refers to a signal quality metric (e.g., RSRP or RSRQ) of a neighbor cell of the UE.

In an embodiment, Qmeas refers to (RSRP) measurement quantity used in cell reselections. That is Qmeas, s refers to (RSRP) measurement quantity used in cell reselections for the serving cell and Qmeas, n refers to (RSRP) measurement quantity used in cell reselections for the neighbor cell.

In an embodiment, Qoffsettemp refers to an offset temporarily applied to a cell.

In an embodiment, the UE identifies itself as the onboard UE if determining that a cell to which the UE accesses is a mobile IAB node. For example, the SIB (system information block) broadcasted by the mobile IAB node may comprise a mobile IAB indication.

In an embodiment, the UE identifies itself as the onboard UE if determining that a relative moving speed between the cell (e.g., the mobile IAB node) and the wireless terminal is smaller than a threshold.

In an embodiment of the UE supporting CAG (closed access group), the UE identifies itself as the onboard UE if determining that a closed access group (CAG) identifier of the cell is in an allowed CAG.

In an embodiment, the UE identifies itself as the onboard UE if determining that at least one tracking area broadcasted by a cell on which the wireless terminal camps is not in a list of Forbidden Tracking Areas for Roaming. In an embodiment, the cell is provided by the mobile IAB node.

FIG. 3 shows a schematic diagram of a process according to an embodiment of the present disclosure. In FIG. 3., the mobile IAB node broadcast a cell reselection parameter SsearchDeltaP-onboard in the system information. In this embodiment, the UE identifies itself as the onboard UE. The onboard UE performs a relaxed measurement identify by taking the SsearchDeltaP-onboard into account. For example, the UE may determine whether to perform the relaxed measurement based on whether:

(Srxlevref−Srxlev)<SSearchdeltaP-onboard,

where:
Srxlev=current Srxlev value of the serving cell (dB);
SrxlevRef=reference Srxlev value of the serving cell (dB), set as the following:
   After selecting or reselecting a new cell, or
   If (Srxlev−SrxlevRef)>0, or
   If the relaxed measurement criterion has not been met for TSearchDeltaP-onboard:
   The UE sets the value of SrxlevRef to the current Srxlev value of the serving cell.

FIG. 4 shows a schematic diagram of a process according to an embodiment of the present disclosure. In FIG. 4, the mobile IAB node broadcast cell reselection parameter SsearchDeltaP-onboard and SsearchThresholdQ-onboard (if configured) in the system information.

In this embodiment, the UE identifies itself as the onboard UE. The onboard UE performs a relaxed measurement identify by taking the SsearchDeltaP-onboard and the SsearchThresholdQ-onboard (if configured) into account. For example, the UE may determine whether to perform the relaxed measurement based on whether:
Srxlev>SSearchThresholdP-onboard, and,
Squal>SSearchThresholdQ-onboard, if SSearchThresholdQ-onboard is configured, where:
Srxlev=current Srxlev value of the serving cell (dB); and
Squal=current Squal value of the serving cell (dB).

FIG. 5 shows a schematic diagram of a process according to an embodiment of the present disclosure. In the present disclosure, the non-F1 terminating IAB-donor is for a boundary IAB node and refers to the IAB-donor that has an RRC (radio resource control) connection with the boundary node but does not terminate F1 (interface) with this boundary node. In addition, the F1 terminating IAB-donor is for the boundary node and refers to the IAB-donor that terminates the F1 (interface) for the boundary IAB node. In an embodiment of partial migration, an inter-donor redundancy or inter-donor RLF recovery. The boundary IAB node refers to an IAB node with one RRC interface terminating at a different IAB-donor-CU (central unit) than the F1 interface.

Specifically, the F1-terminating IAB-donor sends a ULI (UE location information) request to the non-F1-terminating IAB-donor, e.g., for ULI of the mobile IAB node. The non-F1-terminating IAB-donor sends the ULI (of the mobile IAB node) to the F1-terminating IAB-donor The F1-terminating IAB-donor sends the received ULI to an AMF (access and mobility management function). After receiving the additional ULI, the AMF determines the UE location by taking the ULI of IAB-UE into account, such as Registration Area management, UE presence in Area of Interest and providing UE location to other NFs, e.g., SMF during PDU Session Establishment.

In an embodiment, the ULI request may be optional. That is the non-F1-terminating IAB-donor may transmit the ULI to the F1-terminating IAB-donor without receiving the ULI request.

FIG. 6 shows a schematic diagram of a process according to an embodiment of the present disclosure. In FIG. 6, mobile IAB-MT (i.e., MT (mobile termination) of the (mobile) IAB node) handover is performed. For example, the mobile IAB-MT (or the mobile IAB node) may be transferred/migrated from a source IAB donor to a target IAB donor. In this embodiment, the source/target IAB donor is a non-F1 terminating IAB donor of the mobile IAB node.

The Non-F1-terminating IAB-donor (e.g., the source IAB donor of the mobile IAB node or the target donor of the mobile IAB node) sends TAC (tracking area code) information to the F1-terminating IAB-donor via Xn or NG interface. The TAC information may comprise a TAC of a parent node of the mobile IAB node or TAC(s) of the cells of donor of the mobile IAB-MT or an allowed TAC list) to the F1-terminating IAB-donor, e.g., via Xn or NG interface.

Upon/after receiving the TAC information, the non-F1-terminating IAB-donor may perform at least one of:
Deciding to perform a transport migration (F1 connection transferred from a source donor DU to a target donor DU) or full migration (MT and DU of the mobile IAB node are both migrated) based on the TAC information, wherein the transport migration may be for making the DU to connect/access to the F1-terminating donor via different parent nodes (e.g., via the source parent node before the transport migration and via the target parent node after transport migration);
Selecting one or more TACs based on the cell number of the mobile IAB-DU (e.g., if/when the TAC information comprises multi TACs): if the selected TAC(s) is not in its Supported TA List, the F1 terminating donor needs to update Supported TA List to the AMF; or
select one or more TACs (e.g., if/when the TAC information comprises multi TACs) and configure the TAC to the mobile IAB node in a transport migration procedure via an F1 signaling (e.g., GNB-DU CONFIGURATION UPDATE ACKNOWLEDGE) or an RRCReconfiguration message.

Upon/after receiving the new TAC(s), the mobile IAB-DU broadcast the received TAC(s) in its SIB.

FIG. 7 shows a schematic diagram of a process according to an embodiment of the present disclosure. In FIG. 7, mobile IAB-MT (i.e., MT of the (mobile) IAB node) handover is performed. For example, the mobile IAB-MT (or the mobile IAB node) may be transferred/migrated from a source IAB donor to a target IAB donor. In this embodiment, the source/target IAB donor is a non-F1 terminating IAB donor of the mobile IAB node.

The Non-F1-terminating donor (e.g., the target IAB donor of the IAB-MT) sends a or several TAC(s) to the mobile IAB node.

Upon/After receiving the TAC(s) from the Non-F1-terminating donor or the SIB of the parent node, the mobile IAB node reports the TAC(s) to the F1-terminating donor via an F1 signaling (e.g., GNB-DU CONFIGURATION UPDATE).

In response to the F1 signaling, the F1-terminating donor transmits an acknowledge to the mobile IAB node. Upon/after receiving the acknowledge from the F1-terminating donor, the mobile IAB-DU broadcast the received TAC(s) in its SIB.

FIG. 8 shows a schematic diagram of a process according to an embodiment of the present disclosure. In FIG. 8, a handover of the DU of the mobile IAB is performed. For example, the DU of the mobile IAB may be transferred/migrated from a source IAB donor to a target IAB donor. In this embodiment, the target IAB donor is an F1 terminating donor for the mobile IAB node (i.e., target F1 terminating donor shown in FIG. 8). The target F1-terminating donor configures a new NGCI (radio cell global identity) to the mobile IAB node, e.g., via F1 SETUP RESPONSE.

Upon/after receiving the new NGCI, the mobile IAB node replaces old NCGI with the new NCGI.

In an embodiment, the target F1-terminating donor also replace the old NCGI with the new NCGI for the mobile IAB node.

FIG. 9 shows a schematic diagram of a process according to an embodiment of the present disclosure. In FIG. 9, a handover of the DU of the mobile IAB is performed. For example, the DU of the mobile IAB may be transferred/migrated from a source IAB donor to a target IAB donor. In this embodiment, the source/target IAB donor is an F1 terminating donor for the mobile IAB node (i.e., source/target F1-terminating donor shown in FIG. 9).

The source F1-terminating donor acquires a new NCGI for the mobile IAB node from the target F1-terminating donor e.g., via an Xn or NG message. In an embodiment, the source F1-terminating donor replaces an old NCGI associated with the mobile IAB node with the new NCGI for the mobile IAB node.

Upon/After receiving the new NCGI, the source F1 terminating donor configure the new NCGI to the mobile IAB node, e.g., via the F1 or RRC message.

After receiving the new NCGI, the mobile IAB node replaces the old NCGI with the new NCGI.

FIG. 10 relates to a schematic diagram of a wireless terminal 100 according to an embodiment of the present disclosure. The wireless terminal 100 may be a user equipment (UE), a mobile phone, a laptop, a tablet computer, an electronic book or a portable computer system and is not limited herein. The wireless terminal 100 may include a processor 1000 such as a microprocessor or Application Specific Integrated Circuit (ASIC), a storage unit 1010 and a communication unit 1020. The storage unit 1010 may be any data storage device that stores a program code 1012, which is accessed and executed by the processor 1000. Embodiments of the storage unit 1010 include but are not limited to a subscriber identity module (SIM), read-only memory (ROM), flash memory, random-access memory (RAM), hard-disk, and optical data storage device. The communication unit 1020 may a transceiver and is used to transmit and receive signals (e.g., messages or packets) according to processing results of the processor 1000. In an embodiment, the communication unit 1020 transmits and receives the signals via at least one antenna 1022 shown in FIG. 10.

In an embodiment, the storage unit 1010 and the program code 1012 may be omitted and the processor 1000 may include a storage unit with stored program code.

The processor 1000 may implement any one of the steps in exemplified embodiments on the wireless terminal 100, e.g., by executing the program code 1012.

The communication unit 1020 may be a transceiver. The communication unit 1020 may as an alternative or in addition be combining a transmitting unit and a receiving unit configured to transmit and to receive, respectively, signals to and from a wireless network node (e.g., a base station).

FIG. 11 relates to a schematic diagram of a wireless network node 110 according to an embodiment of the present disclosure. The wireless network node 110 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 110 may comprise (perform) at least one network function such as an access and mobility management function (AMF), a session management function (SMF), a user place function (UPF), a policy control function (PCF), an application function (AF), etc. The wireless network node 110 may include a processor 1100 such as a microprocessor or ASIC, a storage unit 1110 and a communication unit 1120. The storage unit 1110 may be any data storage device that stores a program code 1112, which is accessed and executed by the processor 1100. Examples of the storage unit 1110 include but are not limited to a SIM, ROM, flash memory, RAM, hard-disk, and optical data storage device. The communication unit 1120 may be a transceiver and is used to transmit and receive signals (e.g., messages or packets) according to processing results of the processor 1100. In an example, the communication unit 1120 transmits and receives the signals via at least one antenna 1122 shown in FIG. 11.

In an embodiment, the storage unit 1110 and the program code 1112 may be omitted. The processor 1100 may include a storage unit with stored program code.

The processor 1100 may implement any steps described in exemplified embodiments on the wireless network node 110, e.g., via executing the program code 1112.

The communication unit 1120 may be a transceiver. The communication unit 1120 may as an alternative or in addition be combining a transmitting unit and a receiving unit configured to transmit and to receive, respectively, signals to and from a wireless terminal (e.g., a user equipment or another wireless network node).

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A wireless communication method for use in a wireless terminal, the method comprising:
receiving, from a wireless network node, at least one configuration parameter for an on-board type terminal,
identifying as the on-board type terminal, and
performing an operation by using the at least one configuration parameter for the on-board type terminal.

2. The wireless communication method of claim 1, wherein the at least one configuration parameter comprises at least one cell reselection parameter for the on-board type terminal, and
wherein performing the operation by using the at least one configuration parameter for the on-board type terminal comprises:
performing a cell reselection process by using the at least one cell reselection parameter.

3. The wireless communication method of claim 2, wherein the at least one configuration parameter comprises a hysteresis value and/or an offset value for the cell reselection.

4. The wireless communication method of claim 2, wherein performing the cell reselection process by using the at least one cell reselection parameter comprises:
determining a serving cell quality metric and/or at least one neighbor cell quality metric by using the at least one cell reselection parameter, and
performing the cell reselection process based on the serving cell quality metric and/or the at least one neighbor cell quality metric.

5. The wireless communication method of claim 1, wherein the at least one configuration parameter comprises a low mobility relaxed measurement threshold and/or an edging cell relaxed measurement, and
wherein performing the operation by using the at least one configuration parameter for the on-board type terminal comprises:
determining whether to perform a relaxed measurement based on the low mobility relaxed measurement threshold and/or the edging cell relaxed measurement threshold.

6. The wireless communication method of claim 1, wherein identifying as the on-board terminal comprises:
identifying as the on-board terminal if:
determining that a cell to which the wireless terminal accesses is a mobile Integrated Access and Backhaul node,
determining that a relative moving speed between the cell and the wireless terminal is smaller than a threshold,
determining that a closed access group (CAG) identifier of the cell is in an allowed closed access group list, wherein the wireless terminal supports CAG functionality, or
determining that at least one tracking area broadcasted by a cell on which the wireless terminal camps is not in a list of Forbidden Tracking Areas for Roaming, wherein the cell is provided by the mobile Integrated Access and Backhaul node.

7. A wireless communication method for use in a wireless network node, the method comprising:
transmitting, to a wireless terminal, at least one configuration parameter for an on-board type terminal.

8. The wireless communication method of claim 7, wherein the at least one configuration parameter comprises at least one cell reselection parameter for the on-board type terminal,
wherein the at least one cell reselection parameter is used for a cell reselection process.

9. The wireless communication method of claim 8, wherein the at least one configuration parameter comprises a hysteresis value and/or an offset value for the cell reselection.

10. The wireless communication method of claim 7, wherein the at least one configuration parameter comprises a low mobility relaxed measurement threshold and/or an edging cell relaxed measurement,
wherein the serving cell quality metric and/or the at least one neighbor cell quality metric is used for determining whether a relaxed measurement is performed by the wireless terminal.

11. A wireless communication method, the method comprising:
receiving, by a first wireless network node from a second wireless network node, location information of a wireless terminal, and
transmitting, by the first wireless network node to an access and mobility management function, the location information;
or,
transmitting, by the second wireless network node to the first wireless network node, the location information of the wireless terminal.

12. The wireless communication method of claim 11, further comprising:
transmitting, by the first wireless network node to the second wireless network node, a request for the location information of the wireless terminal.

13. The wireless communication method of claim 11, wherein the first wireless network node and the second wireless network node are integrated access and backhaul donors of the wireless terminal.

14. The wireless communication method of claim 11, wherein the first wireless network node is an F1-terminating integrated access and backhaul donor of the wireless terminal and the second wireless network node is a non-F1-terminating integrated access and backhaul donor of the wireless terminal.

15. (canceled)

16. The wireless communication method of claim 11, further comprising:
receiving, by the second wireless network node from the first wireless network node, a request for the location information of the wireless terminal.

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. A non-transitory computer program product comprising a computer-readable program medium code stored thereupon, the code, when executed by a processor, causing the processor to implement a wireless communication method recited in claim 1.

63. A non-transitory computer program product comprising a computer-readable program medium code stored thereupon, the code, when executed by a processor, causing the processor to implement a wireless communication method recited in claim 7.

64. A non-transitory computer program product comprising a computer-readable program medium code stored thereupon, the code, when executed by a processor, causing the processor to implement a wireless communication method recited in claim 11.

65. A wireless terminal comprising a processor and a storage unit, wherein the storage unit stores a program code, and the program code, when being accessed and executed by the processor, causes the processor to implement a wireless communication method recited in claim 1.

66. A wireless terminal comprising a processor and a storage unit, wherein the storage unit stores a program code, and the program code, when being accessed and executed by the processor, causes the processor to implement a wireless communication method recited in claim 7.
